(19) United States
(12) Patent Application Publication
(10) Pub. No.: US 2025/0373031 A1
(43) Pub. Date: Dec. 4, 2025

(54) ENERGY STORAGE DEVICE ALTERNATING CURRENT MULTI-PHASE SYSTEM AND ELECTRIC QUANTITY BALANCE CONTROL NETHOD THEREFOR

(71) Applicant: SHENZHEN POWEROAK NEWENER CO.,LTD, Shenzhen (CN)

(72) Inventors: Hui Ma, Shenzhen (CN); Jianhua Lei, Shenzhen (CN); Zhihua Guo, Shenzhen (CN); Geng Qin, Shenzhen (CN); Wentao Cang, Shenzhen (CN); Fan Li, Shenzhen (CN)

(21) Appl. No.: 19/298,304

(22) Filed: Aug. 13, 2025

Related U.S. Application Data
(63) Continuation of application No. PCT/CN2023/128065, filed on Oct. 31, 2023.

(30) Foreign Application Priority Data
Apr. 11, 2023 (CN) 202310376686.3
Apr. 11, 2023 (CN) 202310376690.X

(51) Int. Cl. H02J 7/00

(52) U.S. Cl. CPC H02J 7/0016; H02J 7/0048; H02J 7/00712

(57) ABSTRACT

An electric quantity balance control method includes: S1: obtaining remaining electric quantities of a plurality of energy storage devices; S2: calculating an average value of the remaining electric quantities of the plurality of energy storage devices; S3: subtracting the average value calculated in step S2 from the remaining electric quantity of each energy storage device to obtain a corresponding difference, and for each energy storage device, if the corresponding difference is greater than 0, increasing an output voltage of the energy storage device to increase its output power, otherwise if the corresponding difference is less than 0, reducing the output voltage of the energy storage device to decrease its output power. According to the energy storage device alternating current multi-phase system and the electric quantity balance control method therefor provided in the present invention, the problem of the overall endurance of the system being greatly shortened is effectively solved.

### TECHNICAL FIELD OF THE INVENTION

The present invention relates to the technical field of energy storage devices, and in particular, relates to an energy storage device alternating current multi-phase system and an electric quantity balance control method therefor.

### BACKGROUND OF THE INVENTION

Energy storage power supply is a kind of device that can store electric energy and release it when needed. Because of its advantages of safety, portability, high efficiency and environmental friendliness, energy storage power supply has been widely used in aerial photography, surveying and mapping, mobile medical care, self-driving travel, picnic and camping, entertainment life and other fields. In addition, the energy storage power supply with large capacity can also provide emergency/standby power supply for families/business, and meet basic requirements of household/business electric loads in the case of power failure.

In the prior art, an AC dual live-wire system composed of two independent energy storage power supplies and an AC three-phase system composed of three independent energy storage power supplies suffer from a greatly shortened overall endurance, because the system can only be shut down due to the inconsistency of batteries of two or three said independent energy storage power supplies when any one of the energy storage power supplies runs out of power. Especially in the case where a single energy storage power supply is connected with a stand-alone load or the stand-alone load of the multiple energy storage power supplies is unbalanced, it will further lead to inconsistent power consumption of the energy storage power supplies included in the system. The energy storage power supply connected with a stand-alone load of a larger power will have a shorter battery duration and its power will run out earlier than that of another energy storage power supply connected with a stand-alone load with a lower power.

The disclosure of the above background is only used to assist in understanding the concept and technical schemes of the present invention, which does not necessarily belong to the prior art of this patent application. In the absence of clear evidence that the above content has been disclosed on the filing date of this patent application, the above background should not be used to evaluate the novelty and creativity of this application.

### SUMMARY OF THE INVENTION

In a first aspect, the present invention discloses an electric quantity balance control method for an energy storage device alternating current multi-phase system, which includes the following steps: S1: obtaining remaining electric quantities of a plurality of energy storage devices; S2: calculating an average value of the remaining electric quantities of the plurality of energy storage devices; S3: subtracting the average value calculated in step S2 from the remaining electric quantity of each energy storage device to obtain a corresponding difference, and for each energy storage device, if the corresponding difference is greater than 0, increasing an output voltage of the energy storage device to increase the output power of the energy storage device, otherwise, if the corresponding difference is less than 0, reducing the output voltage of the energy storage device to decrease the output power of the energy storage device.

In some embodiments, the step S3 specifically includes: subtracting the average value SOCₐᵥₑ calculated in step S2 from the remaining electric quantity SOCᵢ of the ith energy storage device to obtain the difference, and adjusting the output voltage of the corresponding energy storage device to a target voltage value U_{iRef} to adjust the output power of the energy storage device, wherein the target voltage value is defined by U_{iRef}=U_{rated}+ΔUᵢ, U_{rated} is the rated voltage of the energy storage device, ΔUᵢ is a target voltage adjustment value calculated according to the difference value, i=1 to n, and n is the number of the energy storage devices.

In some embodiments, the target voltage adjustment value is defined by: ΔUᵢ=(SOCᵢ−SOCₐᵥₑ)×U_{rated},.

In some embodiments, after step S3, the method further includes iteratively executing steps S1 to S3 until the remaining electric quantities of all the energy storage devices become equal.

In some embodiments, the step S3 specifically includes:
subtracting the average value SOCₐᵥₑ calculated in step S2 from the remaining electric quantity SOC_{i_j} of the ith energy storage device to obtain the difference value, and adjusting the output voltage of the corresponding energy storage device to a stepping target voltage value U_{iRef} to adjust the output power of the energy storage device, wherein the stepping target voltage value is defined by U_{iRef}=U_{rated}+ΔU_{i_j}, U_{rated} is the rated voltage of the energy storage device, ΔU_{i_j} is a target voltage adjustment value at the jth voltage adjustment performed on the ith energy storage device that is calculated according to the difference, i=1 to n, n is the number of the energy storage devices, and j is the current number of times for voltage adjustment.

In some embodiments, the target voltage adjustment value at the jth voltage adjustment performed on the ith energy storage device is defined by:

$$Δ {U}_{i \_ j} = Δ {U}_{SOC \_ i \_ j} * r {2}_{i} + Δ {U}_{p \_ i \_ j} * r {3}_{i} ;$$

wherein ΔU_{sOC_i_j} is a first target voltage adjustment value at the jth voltage adjustment performed on the ith energy storage device that is calculated according to the difference, ΔU_{p_i_j} is a second target voltage adjustment value at the jth voltage adjustment performed on the ith energy storage device that is calculated according to the change of the AC side output power of the ith energy storage device, r2ᵢ and r3ᵢ are weights, and r2ᵢ+r3ᵢ=1.

In some embodiments, the first target voltage adjustment value at the jth voltage adjustment performed on the ith energy storage device is defined by: ΔU_{sOC_i_j}=(SOCᵢ_{ⱼ}−SOCₐᵥₑ)×U_{rated}×r1ᵢ, wherein r1ᵢ is a proportional coefficient.

In some embodiments, the value of r1ᵢ is 10% to 20%.

In some embodiments, the second target voltage adjustment value at the jth voltage adjustment performed on the ith energy storage device is defined by: ΔU_{p_i_j}=K_{u_i_j}*ΔU_{sOC_i_j}, wherein K_{u_i_j} is the power change ratio at the jth voltage adjustment performed on the ith energy storage device, and K_{u_i_j}=(P_{m_i_j}−P_{m_k0_i_j})/P_{mMean_i_j}, wherein P_{m_i_j} is the AC side output power at the jth voltage adjustment performed on the ith energy storage device, P_{mMean_i_j} is a periodic average of the AC side output power at the jth voltage adjustment performed on the ith energy storage device that is calculated by using sliding window filtering, and P_{m_k0_i_j} is the power value excluded from the sliding window filter at the jth voltage adjustment performed on the ith energy storage device.

In a second aspect, the present invention discloses an energy storage device alternating current multi-phase system, which includes: a plurality of energy storage devices and a system load, wherein the plurality of energy storage devices are in communication with each other, and the AC output side live wires of the plurality of energy storage devices are respectively connected to the system load, the neutral wires of the plurality of energy storage devices are connected to the neutral wire common point of the system load; the energy storage device alternating current multi-phase system is configured to perform electric quantity balance control on the plurality of energy storage devices using the electric quantity balance control method as described in the first aspect.

In some embodiments, the energy storage device alternating current multi-phase system further includes at least one stand-alone load, and the AC output side of at least one of the plurality of energy storage devices is separately connected with the stand-alone load.

In some embodiments, it further includes the following steps before the step S1: enabling the plurality of energy storage devices to communicate with each other for allocation of master and slave devices, and determining one of the plurality of energy storage devices as the master device and the other energy storage devices as the slave devices.

In some embodiments, the master device is configured to: send a power frequency phase signal to the slave device when the power frequency cycle of the master device crosses zero; obtain the remaining electric quantities of the plurality of energy storage devices; obtain the target voltage value of each of the energy storage devices according to the electric quantity balance control method described in the first aspect and send it to the corresponding slave device.

In some embodiments, the slave device is configured to: obtain and track the power frequency phase signal sent by the master device, and control the power frequency phase of the slave device to lag behind the power frequency phase of the master device.

In some embodiments, the number of the energy storage devices is two, the energy storage device alternating current multi-phase system is a split-phase dual live-wire system, and the power frequency phase of the slave device lags behind the power frequency phase of the master device by 180°.

In some embodiments, the number of the energy storage devices is three, the energy storage device alternating current multi-phase system is a three-phase four-wire system, the number of the slave devices is two, and the power frequency phase difference among the three energy storage devices is 120°.

In a third aspect, the present invention discloses a storage medium storing a computer program, wherein the computer program is set to be executable by a processor to execute the electric quantity balance control method described in the first aspect.

### BRIEF DESCRIPTION OF THE DRAWINGS

FIG. 1 is a flowchart diagram of an electric quantity balance control method for an energy storage device alternating current multi-phase system in the embodiment 1 of the present invention.

FIG. 2 is a block diagram of a split-phase double-live wire system in the preferred embodiment based on the embodiment 1 of the present invention.

FIG. 3 is a flowchart diagram illustrating phase control for master and slave devices of the split-phase double-live wire system in another preferred embodiment based on the embodiment 1 of the present invention.

FIG. 4 is a schematic view of adjusting the output power to balance the SOC in the split-phase dual-live wire system in another preferred embodiment based on the embodiment 1 of the present invention.

FIG. 5 is a control flowchart diagram for adjusting the output voltage to balance the SOC in the split-phase double-live wire system in another preferred embodiment based on the embodiment 1 of the present invention.

FIG. 6 is a block diagram of a three-phase four-wire system in another preferred embodiment based on the embodiment 1 of the present invention.

FIG. 7 is a flowchart diagram of an electric quantity balance control method for an energy storage device alternating current multi-phase system in the embodiment 2 of the present invention.

FIG. 8 is a block diagram of a split-phase double-live wire system in the preferred embodiment based on the embodiment 2 of the present invention.

FIG. 9 is a schematic view of adjusting the output power to balance the SOC in the split-phase dual-live wire system in another preferred embodiment based on the embodiment 2 of the present invention.

FIG. 10 is a control flowchart diagram for adjusting the output voltage to balance the SOC in the split-phase double-live wire system in another preferred embodiment based on the embodiment 2 of the present invention.

FIG. 11 is a block diagram of a three-phase four-wire system in another preferred embodiment based on the embodiment 2 of the present invention.

### DETAILED DESCRIPTION

Hereinafter, embodiments of the present invention will be described in detail. It should be emphasized that the following description is only exemplary, and is not intended to limit the scope and application of the present invention.

It shall be noted that when an element is said to be “fixed” or “disposed” on another element, it may be directly or indirectly located on the other element. When an element is said to be “connected” to another element, it may be directly or indirectly connected to the other element. In addition, the connection may be used for both fixing function and circuit/signal communication function.

It shall be appreciated that orientation or positional relationships indicated by terms such as “length”, “width”, “upper”, “lower”, “front”, “rear”, “left”, “right”, “vertical”, “horizontal”, “top”, “bottom”, “inner” and “outer” are orientation or positional relationships based on the attached drawings. These terms are only for the convenience of describing the embodiments of the present invention and simplifying the description, and do not indicate or imply that the referred devices or elements must have a specific orientation or must be constructed and operated in a specific orientation, and thus these terms should not be construed as limitations to the present invention.

In addition, terms “first” and “second” are only used for descriptive purposes, and should not be construed as indicating or implying relative importance or implicitly indicating the number of the indicated technical features. Thus, the features defined by the terms “first” and “second” may explicitly or implicitly include one or more said features. In the description of the embodiment of the present invention, the term “more” means two or more, unless otherwise specifically defined.

### Embodiment 1

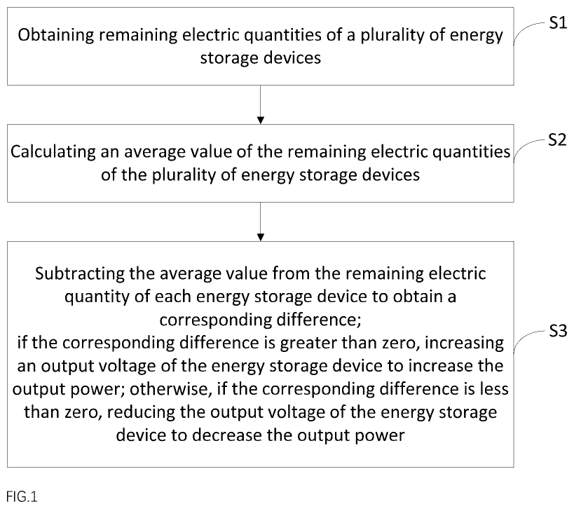

As shown in FIG. 1, the embodiment 1 of the present invention discloses an electric quantity balance control method for an energy storage device alternating current multi-phase system, which includes the following steps: S1: obtaining remaining electric quantities of a plurality of energy storage devices; S2: calculating an average value of the remaining electric quantities of the plurality of energy storage devices; S3: subtracting the average value calculated in step S2 from the remaining electric quantity of each energy storage device to obtain a corresponding difference, and for each energy storage device, if the corresponding difference is greater than 0, increasing an output voltage of the energy storage device so as to increase output power of the energy storage device, otherwise, if the corresponding difference is less than 0, reducing the output voltage of the energy storage device so as to decrease the output power of the energy storage device.

The step S3 specifically includes: subtracting the average value SOCₐᵥₑ calculated in step S2 from the remaining electric quantity SOCᵢ of the ith energy storage device to obtain the difference, and adjusting the output voltage Uᵢ of the corresponding energy storage device to a target voltage value U_{iRef} to adjust the output power of the energy storage device, wherein the target voltage value is defined by U_{iRef}=U_{rated}+ΔUᵢ, U_{rated} is the rated voltage of the energy storage device, ΔUᵢ is a target voltage adjustment value calculated according to the difference, i=1 to n, and n is the number of the energy storage devices. In some embodiments, the target voltage adjustment value is defined by ΔUᵢ=(SOCᵢ−SOCₐᵥₑ)×U_{rated}.

The embodiment 1 of the present invention further discloses an energy storage device alternating current multi-phase system, which includes: a plurality of energy storage devices and a system load, wherein the plurality of energy storage devices are in communication with each other, and the AC output side live wires of the plurality of energy storage devices are respectively connected to the system load, the neutral wires of the plurality of energy storage devices are connected to the neutral wire common point of the system load; the energy storage device alternating current multi-phase system adopts the electric quantity balance control method as described in the above embodiment to perform electric quantity balance control on the plurality of energy storage devices.

The method further includes the following steps before step S1: enabling the plurality of energy storage devices to communicate with each other for allocation of master and slave devices, and determining one of the plurality of energy storage devices as the master device and the other energy storage devices as the slave devices. In some embodiments, the master device is configured to: send a power frequency phase signal to the slave device when the power frequency cycle of the master device crosses zero; obtain the remaining electric quantities of the master device and each slave device; obtain the target voltage values of the master device and each slave device according to the electric quantity balance control method as described in the above embodiment and send the target voltage values to the corresponding slave device. The slave device is configured to: obtain and track the power frequency phase signal sent by the master device, and control the power frequency phase of the slave device to lag behind the power frequency phase of the master device.

In some embodiments, the number of the energy storage devices is two, the energy storage device alternating current multi-phase system is a split-phase dual live-wire system, and the power frequency phase of the slave device lags behind the power frequency phase of the master device by 180°. In some other embodiments, the number of the energy storage devices is three, the energy storage device alternating current multi-phase system is a three-phase four-wire system, the number of the slave devices is two, and the power frequency phase difference among the three energy storage devices is 120°.

The embodiment 1 of the present invention further discloses a storage medium which is characterized by storing a computer program, wherein the computer program is set to be executable by a processor to execute the steps of the electric quantity balance control method described in the above embodiment 1.

Optionally, the above storage medium may include, but is not limited to, various media that can store computer programs, such as a USB flash disk, a Read-Only Memory (ROM), a Random Access Memory (RAM), a mobile hard disk, a magnetic disk or an optical disk.

As compared to the prior art, the beneficial effects of the present invention lie in that: in the energy storage device alternating current multi-phase system and the electric quantity balance control method therefor according to the present invention, the output power of the energy storage devices is adjusted by adjusting the output voltage of the energy storage devices according to the remaining electric quantities of the energy storage devices, thereby realizing the active electric quantity balance control of the energy storage device alternating current multi-phase system, and effectively solving the problem that the on-load endurance of the system is shortened due to inconsistent SOC.

In the further scheme, the output power of the energy storage devices is adjusted by gradually adjusting the output voltage of the energy storage devices stepwise according to the remaining electric quantities of the energy storage devices, and the stability of the respective stand-alone load is taken into consideration in each adjustment of the output voltage. By gradually adjusting the output voltage of the energy storage devices stepwise in a cyclic manner, the power fluctuation of the stand-alone load is prevented so that the stand-alone load can work and be used normally under the rated voltage and within a certain voltage variation range, thereby making the system more stable. On the one hand, it avoids the inconsistency of power consumption of the energy storage devices included in the system, so that the battery duration of the energy storage devices is consistent. On the other hand, it ensures that all kinds of electrical devices can work and be used normally under the rated voltage and within a certain voltage variation range, and at the same time, it also avoids the operation of stand-alone loads under the condition of high or low voltages, thereby greatly prolonging the service life of the electrical devices, reducing energy consumption, reducing the possibility of electrical device damage to the greatest extent, and ensuring electrical safety.

The energy storage device alternating current multi-phase system and the electric quantity balance control method therefor provided in the above embodiment 1 of the present invention will be further described hereinafter with reference to specific preferred embodiments.

The embodiment 1 of the present invention preferably provides a split-phase dual-live wire system, which is composed of two independent energy storage power supplies with AC output sides connected in series with an AC output phase difference of 180°, and neutral wires connected together to form a split-phase LI-N-L2 AC power supply system. Through the split-phase double-live wire system, the output AC voltage can be multiplied.

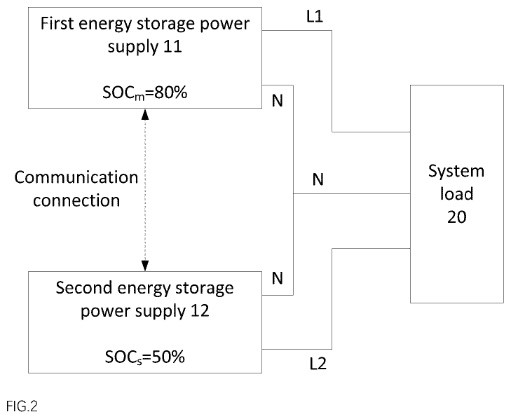

Specifically, as shown in FIG. 2, the split-phase dual-live wire system includes a first energy storage power supply 11 and a second energy storage power supply 12 that can output alternating current off grid and a system load 20 (in this embodiment, the system load is a dual-live wire load). The first energy storage power supply 11 and the second energy storage power supply 12 are in communication with each other, the AC output side neutral wires (N) of the first energy storage power supply 11 and the second energy storage power supply 12 are connected to the neutral wire common point of the system load 20, and the live wire (L1) of the first energy storage power supply 11 and the live wire (L2) of the second energy storage power supply 12 are respectively connected to the system load 20.

The output voltage U₁ of the first energy storage power supply 11 and the output voltage U₂ of the second energy storage power supply 12 in the split-phase dual-live wire system at the initial moment are both rated AC output voltage value U_{rated} (100 Vac or 120 Vac).

In some embodiments, the electric quantity balance control method of the split-phase dual-live wire system includes the following steps:
A1: allocating master and slave devices;

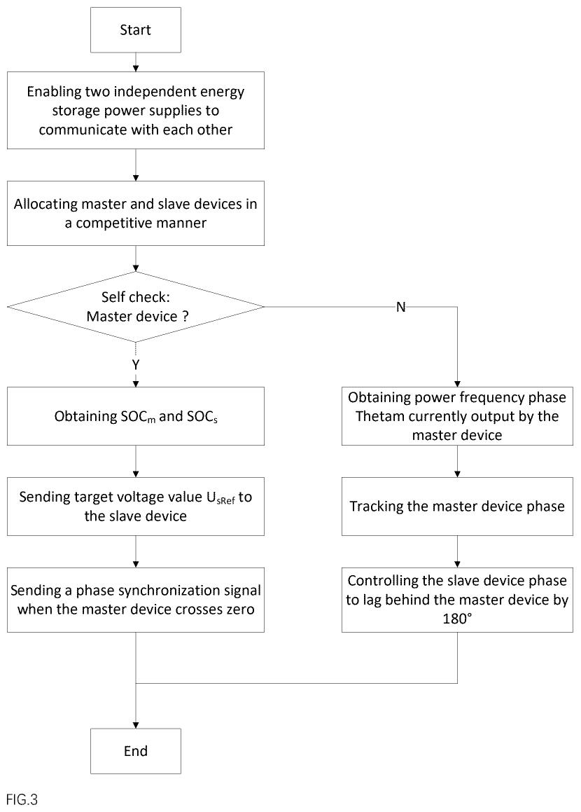

As shown in FIG. 3, the specific steps of allocating the master and slave devices include: enabling two independent energy storage power supplies to communicate with each other, and then allocating the master and slave devices in a competitive manner to confirm whether the power supply is the master device; if the power supply is the master device, then obtaining its current remaining electric quantity SOCₘ, and the current remaining electric quantity SOCₛ of the slave device, and calculating the target voltage value U_{mRef} of the master device and the target voltage value U_{sRef} of the slave device, and then sending the corresponding target voltage value U_{sRef} to the slave device, and further sending a phase synchronization signal to the slave device when the master device crosses zero; if the power supply is not the master device, then obtaining the power frequency phase Thetam currently output by the master device, tracking the master device phase, controlling the slave device phase to lag behind the master device by 180 degrees, and obtaining the its target voltage value U_{sRef} sent by the master device.

In this embodiment, the first energy storage power supply 11 and the second energy storage power supply 12, which are independent of each other, communicate with each other to compete for the master device so that one is automatically allocated to be the master device and the other is allocated to be the slave device. In this embodiment, taking the case where the first energy storage power supply 11 is allocated to be the master device and the second energy storage power supply 12 is allocated to be the slave device as an example, then Uₘ=U₁=U_{rated}, Uₛ=U₂=U_{rated}, wherein U₁ represents the output voltage of the first energy storage power supply 11, U₂ represents the output voltage of the second energy storage power supply 12, Uₘ represents the output voltage of the master device, and Uₛ represents the output voltage of the slave device. The output voltages of the master device and the slave device are all equal to the rated AC output voltage value U_{rated} at the initial moment. The master device is configured to obtain its remaining electric quantity SOCₘ, and the current remaining electric quantity SOCₛ of the slave device, calculate the target voltage value U_{mRef} of the master device and the target voltage value U_{sRef} of the slave device, and then send the corresponding target voltage value U_{sRef} to the slave device. The master device is further configured to send a power frequency phase signal to the slave device when the power frequency cycle of the master device crosses zero. The slave device is configured to obtain and track the power frequency phase signal sent by the master device, and at the same time, control the output phase of the slave device to differ from that of the master device by 180°.

In addition, it should be noted that in some embodiments, the master and slave devices may also be allocated in other ways for the energy storage power supplies. For example, one of the energy storage devices (that is, the energy storage power supply in this embodiment) is taken as the master device by separately providing a control unit in the energy storage device, and other energy storage devices are taken as the slave devices. In the above embodiment, only one slave device is involved, and in the case involving multiple slave devices, the address allocation of slave devices can be done by any existing slave device address allocation method. For example, 1) address allocation is completed by free competition; 2) the address is set for each slave device by setting the dip switch; 3) the address of each slave device is set through the keyboard or human-machine interface; 4) the address of the slave devices is set one by one through the computer serial port software; 5) the slave device inquires the status of the bus to constantly wait for the idle state to communicate with the master device, and the address is reassigned if there is a station address conflict.

A2: obtaining remaining electric quantities of a plurality of energy storage power supplies, and calculating an average value of the remaining electric quantities of the plurality of energy storage power supplies; and then subtracting the average from the remaining electric quantity of each energy storage power supply to obtain a corresponding difference, and for each energy storage power supply, if the corresponding difference is greater than 0, increasing an output voltage of the energy storage power supply so as to increase output power of the energy storage power supply, otherwise, if the corresponding difference is less than 0, reducing the output voltage of the energy storage power supply so as to decrease the output power of the energy storage power supply.

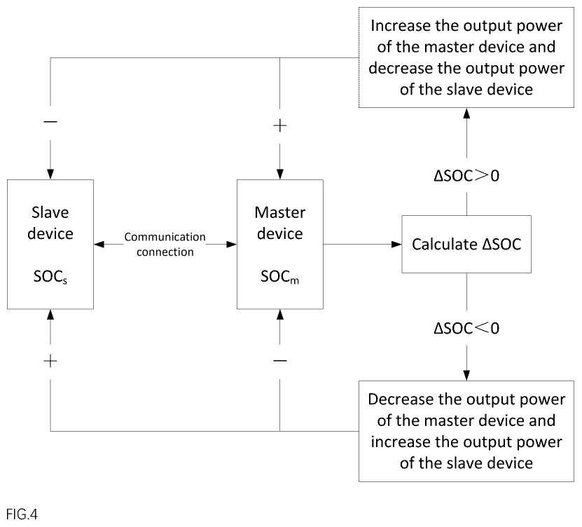

In this embodiment, the difference between the remaining electric quantities of the two energy storage power supplies is directly obtained, and electric quantity balance and output voltage control are carried out according to the difference being greater than 0 or less than 0. Specifically, as shown in FIG. 4, the master device calculates the current SOC difference between the master device and the slave device, denoted as ΔSOC=SOCₘ−SOCₛ; and the master device enters the electric quantity balance-output voltage control mode based on the current SOC difference ΔSOC.

(1) If the master device determines that the current ΔSOC>0, then the current electric quantity of the master device is higher than that of the slave device; the master device increases the output power and the slave device decreases the output power, thus realizing SOC equalization;

(2) if the master device determines that the current ΔSOC<0, then the current electric quantity of the master device is lower than that of the slave device; the master device decreases the output power and the slave device increases the output power, thus realizing SOC equalization.

The output port wire voltage U_{LL} (i.e., the line voltage between L1 and L2) of the system load 20 is equal to the sum of the master device output voltage Uₘ and the slave device output voltage Uₛ, that is, U_{LL}=Uₘ+Uₛ. In order to ensure the stability of on-load output, the split-phase dual-live wire system controls the output port wire voltage U_{LL} to remain constant, i.e., 2 times of the rated voltage U_{rated}, such that U_{LL}=U_{rated}*2. Therefore, the total output voltage of the split-phase dual-live wire system composed of two independent energy storage power supplies remains constant, i.e., Uₘ+Uₛ=U_{rated}*2. Moreover, the AC output sides of the two energy storage power supplies in the split-phase dual-live wire system are connected in series, so the AC side currents of the two energy storage power supplies are equal, i.e., Iₘ=Iₛ, wherein Iₘ is the current of the master device (i.e., the first energy storage power supply 11) and Iₛ is the current of the slave device (i.e., the second energy storage power supply 12).

The output currents of the two energy storage power supplies in the split-phase double-live wire system are equal, so the adjustment of the output power of the energy storage power supply is realized by adjusting the AC output voltage. For example, if it is needed to increase the output power Pₘ of the master device, then it is necessary to increase the current output voltage Uₘ of the energy storage power supply to its corresponding target voltage value U_{mRef}, where U_{mRef}=U_{rated}+ΔU, and Pₘ=Uₘ*Iₘ. Moreover, the output wire voltage of the split-phase dual-live wire system is defined by U_{LL}=U_{rated}*2=Uₘ+Uₛ. Since the output wire voltage of the system load 20 remains constant, when the output voltage of the master device increases, the slave device should correspondingly reduce its output voltage (reducing the current output voltage Uₛ of the energy storage power supply to its corresponding target voltage value U_{sRef}), to decrease the output power thereof, i.e., U_{sRef}=U_{rated}−ΔU, Pₛ=Uₛ*Iₛ.

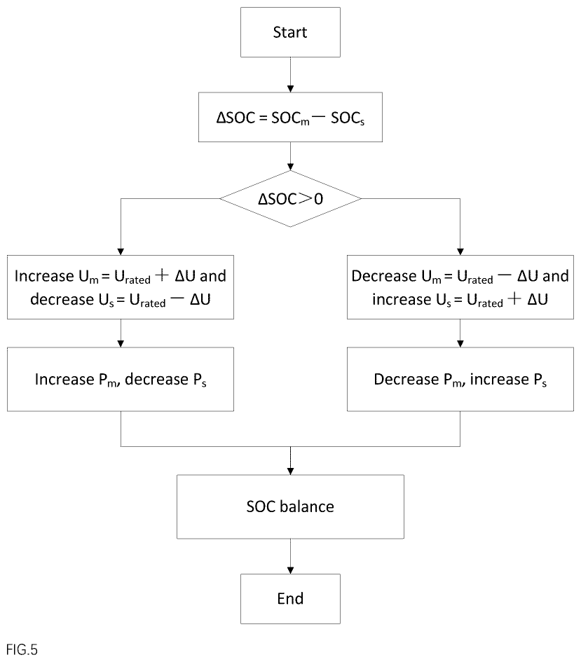

As shown in FIG. 5, when ΔSOC>0, the output voltage of the master device is increased, i.e., Uₘ=U_{mRef}=U_{rated}+ΔU, and the output voltage of the slave device is decreased, i.e., Uₛ=U_{sRef}=U_{rated}−ΔU, so as to further increase the output power Pₘ of the master device and decrease the output power Pₛ of the slave device, thus realizing SOC equalization. When ΔSOC<0, the output voltage of the master device is decreased, i.e., Uₘ=U_{mRef}=U_{rated}−ΔU, and the output voltage of the slave device is increased, i.e., Uₛ=U_{sRef}=U_{rated}+ΔU, so as to further decrease the output power Pₘ, of the master device and increase the output power Pₛ of the slave device, thus realizing SOC equalization.

By dynamically adjusting the target voltage value U_{mRef} of the master device and the target voltage value U_{sRef} of the slave device, the dynamic adjustment of the output power Pₘ, of the master device and the output power Pₛ of the slave device is realized, so as to further realize the adjustment of the battery discharge rate of the energy storage power supply and actively balance the SOC of the two energy storage power supplies.

The target voltage adjustment value is defined by ΔU=(SOC/2)*U_{rated}, wherein SOCₘ, SOCₛ and ΔSOC are all numbers from 0 to 1, which are expressed in percentage form. For example, the SOCₘ, of the master device is 80%, the SOCₛ of the slave device is 50% and ΔSOC is 30%.

The embodiment 1 of the present invention further preferably provides a three-phase four-wire system, which is composed of three independent energy storage power supplies with AC output sides connected in star configuration with respective AC output phase difference of 120°, and neutral wires connected together to form a three-phase AC power supply system.

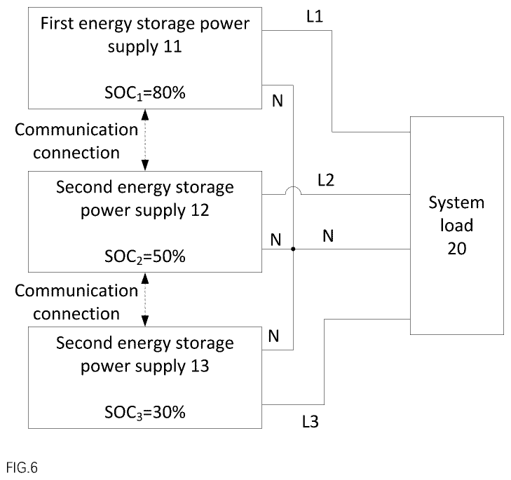

Specifically, as shown in FIG. 6, the three-phase four-wire system includes a first energy storage power supply 11, a second energy storage power supply 12 and a third energy storage power supply 13 that can output alternating current off grid and a system load 20 (in this embodiment, the system load is a three-phase load). The first energy storage power supply 11, the second energy storage power supply 12 and the third energy storage power supply 13 are in communication with each other, the AC output side neutral wires (N) of the first energy storage power supply 11, the second energy storage power supply 12 and the third energy storage power supply 13 are connected to the neutral wire common point of the system load 20, and the live wire (L1) of the first energy storage power supply 11, the live wire (L2) of the second energy storage power supply 12 and the live wire (L3) of the third energy storage power supply 13 are respectively connected to the system load 20.

The output voltage U₁ of the first energy storage power supply 11, the output voltage U₂ of the second energy storage power supply 12 and the output voltage U₃ of the third energy storage power supply 13 in the three-phase four-wire system at the initial moment are all rated AC output voltage value U_{rated} (100 Vac or 120 Vac).

In some embodiments, the electric quantity balance control method of the three-phase four-wire system includes the following steps:
B1: allocating master and slave devices;

The specific steps of allocating the master and slave devices include: enabling three independent energy storage power supplies to communicate with each other, and automatically allocating the master and slave devices in a competitive manner so that one of the energy storage power supplies is determined as the master device while the other two energy storage power supplies are determined as the slave devices. The specific steps in the master and slave device allocation in this three-phase four-wire system differ from those in the split-phase dual-live wire system only in that the phase difference between the master device and the respective slave devices is 120°, while other specific process steps are the same, and this will not be further described herein.

B2: obtaining remaining electric quantities of a plurality of energy storage power supplies, and calculating an average value of the remaining electric quantities of the plurality of energy storage power supplies; and then subtracting the average value from the remaining electric quantity of each energy storage power supply to obtain a corresponding difference, and for each energy storage power supply, if the corresponding difference is greater than 0, increasing an output voltage of the corresponding energy storage power supply so as to increase output power of the energy storage power supply, otherwise, if the corresponding difference is less than 0, reducing the output voltage of the energy storage power supply so as to decrease the output power of the energy storage power supply.

In this embodiment, the master device obtains the remaining electric quantities SOC₁, SOC₂, SOC₃ of the energy storage power supplies; the phase difference between the master device and the respective slave devices is 120°, and the total output voltage of the three-phase four-wire system composed of the three independent energy storage power supplies remains constant.

The average value SOC of the three energy storage power supplies is calculated by: SOCₐᵥₑ=(SOC₁+SOC₂+SOC₃)/3, and then the current SOCᵢ(i=1, 2, 3) of the energy storage power supplies is compared with SOCₐᵥₑ. If SOCᵢ is equal to SOCₐᵥₑ, then there is no need to increase or decrease the output power; if SOCᵢ<SOCₐᵥₑ, then the output power is decreased; and if SOCᵢ>SOCₐᵥₑ, then the output power is increased.

Because the total output voltage remains unchanged and the three-phase load remains unchanged, the total current I is unchanged, and thus the output power of each energy storage power supply is further increased or decreased by adjusting the voltage of each energy storage power supply in the present invention. The output voltage U₁ of the first energy storage power supply 11 is adjusted to its corresponding target voltage value U_{iRef}=U_{rated}+ΔU₁; the output voltage U₂ of the second energy storage power supply 12 is adjusted to its corresponding target voltage value U_{2Ref}=U_{rated}+ΔU₂; the output voltage U₃ of the third energy storage power supply 13 is adjusted to its corresponding target voltage value U_{3Ref}=U_{rated}+ΔU₃; wherein ΔU₁+ΔU₂+ΔU₃=0. If the target voltage adjustment value ΔUᵢ (i=1, 2, 3) is zero, then it means that the remaining electric quantity of the corresponding energy storage power supply SOCᵢ=SOCₐᵥₑ, and there is no need to increase or decrease the output power; if ΔUᵢ is negative, then it means that for the corresponding energy storage power supply, SOCᵢ<SOCₐᵥₑ, and the output power needs to be decreased; and if ΔUᵢ is positive, then it means that for the corresponding energy storage power supply, SOCᵢ>SOCₐᵥₑ, and the output power needs to be increased.

The equation for calculation of the target voltage adjustment value is: ΔUᵢ=(SOCᵢ−SOCₐᵥₑ)×U_{rated}, i=1,2,3, and U_{rated} is the rated voltage of the energy storage power supply. Both SOCᵢ and SOCₐᵥₑ are numbers from 0 to 1, which are expressed in percentage form. For example, the remaining electric quantity SOC₁ of the first energy storage power supply 11 is 80%, the remaining electric quantity SOC₂ of the second energy storage power supply 12 is 50%, the remaining electric quantity SOC₃ of the third energy storage power supply 13 is 30%, and SOCₐᵥₑ is 53.3%.

By adopting the electric quantity balance control method provided in the first preferred embodiment of the present invention, the split-phase dual-live wire system and the three-phase four-wire system described above control the output wire voltage to be constant, thereby providing stable power support for the load. Meanwhile, the output voltage of each single energy storage power supply can be adjusted in real time according to the remaining electric quantity SOC of each energy storage power supply and the power of the load so as to: increase the output on-load power of the energy storage power supply with high electric quantity, and decrease the output on-load power of the energy storage power supply with low electric quantity. Thus, the active electric quantity balance control of the split-phase double-live wire system and the three-phase four-wire system is realized, and the problem that the on-load endurance of the system is shortened due to inconsistency of the remaining electric quantities SOC is effectively solved.

### Embodiment 2

The power grid in each country or region has its own unique voltage standard, and the common voltage standards are 110V, 220V and 240V or the like. Some countries use many different voltages. For example, in the United States, single-phase, single-phase three-wire and three-phase power supply systems are very popular, so single-phase electric power (120V), double live-wire output (240V) and three-phase electric power (208V) are available. The single-phase electric power (120V) is used for small common household loads, such as lighting, heating and small appliances. It provides constant AC current, which flows in a single direction, and has a single sine wave form. The dual-live wire output (240V) is used for larger loads, such as air conditioners, electric furnaces and washing machines or other heavy appliances. The dual-live wire output enables larger electrical loads to operate at lower current, thereby reducing the energy loss caused by heat. The dual-wire output is also commonly used in industrial and commercial places. In China, the three-phase four-wire power system is adopted. The electric power used in households is generally 220V, while that in factories is usually 380V. Based on these voltage standards and different power supply methods, the operating voltages of electrical devices (i.e., loads) are usually different, some electrical devices operate at 120V, some at 240V, and some at 380V.

The AC dual-live wire system composed of two independent energy storage power supplies or the AC three-phase system composed of three independent energy storage power supplies can meet different operating voltage requirements of different electrical loads. On the one hand, multiple energy storage power supplies are combined into one system for joint output (including dual-live wire output and three-phase power output), which can supply power for system load with large voltage requirements. On the other hand, each energy storage power supply still retains its single-phase power output at the rated voltage, which can supply power for single-phase loads (also called stand-alone loads) with small voltage requirements.

In an AC multi-phase system composed of multiple energy storage power supplies, when any energy storage power supply runs out of power, the dual-live wire output or three-phase power output cannot be supported, which results in system shutdown. Especially in the case where a single energy storage power supply is connected with a stand-alone load or the stand-alone load of the multiple energy storage power supplies is unbalanced, it will further lead to inconsistent power consumption of the energy storage power supplies included in the system. The energy storage power supply connected with a stand-alone load of a larger power will have shorter battery duration and its power will run out earlier than that of other energy storage power supplies connected with a stand-alone load with a lower power. On the other hand, all kinds of electrical devices can only work and be used normally under the rated voltage and within a certain voltage variation range. If the fluctuation of AC output voltage of each single energy storage power supply exceeds the allowable range, it will make the stand-alone loads operate under the condition of high or low voltage, which will directly shorten the service life of the electrical device, increase energy consumption, increase the possibility of electrical device damage and even endanger the safety of electricity use.

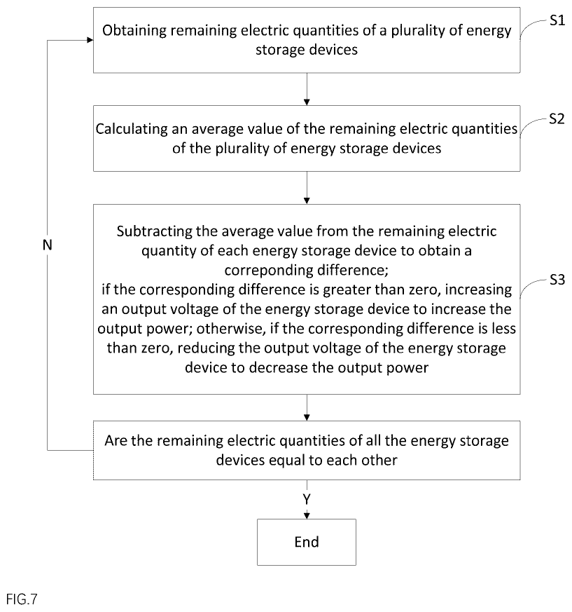

In order to effectively solve the problem that the on-load endurance of the system is shortened due to the inconsistency of the remaining electric quantities SOC, while taking the service life of the stand-alone load and electrical safety as well as system stability into consideration, as shown in FIG. 7, the embodiment 2 of the present invention discloses an electric quantity balance control method for an energy storage device alternating current multi-phase system, which includes the following steps: S1: obtaining remaining electric quantities of a plurality of energy storage devices; S2: calculating an average value of the remaining electric quantities of the plurality of energy storage devices; S3: subtracting the average value calculated in step S2 from the remaining electric quantity of each energy storage device to obtain a corresponding difference, and for each energy storage power supply, if the corresponding difference is greater than 0, increasing an output voltage of the energy storage device so as to increase output power of the energy storage device, otherwise, if the corresponding difference is less than 0, reducing the output voltage of the energy storage device so as to decrease the output power of the energy storage device; and iteratively executing steps S1 to S3 until the remaining electric quantities of all the energy storage devices become equal.

The step S3 specifically includes: subtracting the average value SOCₐᵥₑ calculated in step S2 from the remaining electric quantity SOC_{i_j} of the ith energy storage device to obtain the difference, and adjusting the output voltage of the corresponding energy storage device to a stepping target voltage value U_{Ref_j} to adjust the output power of the energy storage device, wherein the stepping target voltage value U_{iRef_j}=U_{rated}+ΔU_{i_j}, U_{rated} is the rated voltage of the energy storage device, ΔU_{i_j} is a target voltage adjustment value at the jth voltage adjustment performed on the ith energy storage device that is calculated according to the difference, i=1 to n, n is the number of the energy storage devices, and j is the current number of times for voltage adjustment.

In some embodiments, the equation for calculation of the target voltage adjustment value at the jth voltage adjustment performed on the ith energy storage device is: ΔU_{i_j}=ΔU_{sOC_i_j}*r2ᵢ+ΔU_{p_i_j}*r3ᵢ; wherein ΔU_{sOC_i_j} is a first target voltage adjustment value at the jth voltage adjustment performed on the ith energy storage device that is calculated according to the difference, ΔU_{p_i_j} is a second target voltage adjustment value at the jth voltage adjustment performed on the ith energy storage device that is calculated according to the change of the AC side output power of the ith energy storage device, r2ᵢ and r3ᵢ are weights, and r2ᵢ+r3ᵢ=1. The equation for calculation of the first target voltage adjustment value at the jth voltage adjustment performed on the ith energy storage device is: ΔU_{sOC_i_j}=(SOCᵢ_{ⱼ}−SOCₐᵥₑ)×U_{rated}×r1ᵢ, wherein r1ᵢ is a proportional coefficient. Specifically, the value of r1ᵢ is 10% to 20%. The equation for calculation of the second target voltage adjustment value at the jth voltage adjustment performed on the ith energy storage device is: ΔU_{p_i_j}=K_{u_i_j}*ΔU_{sOC_i_j}, wherein K_{u_i_j} is the power change ratio at the jth voltage adjustment performed on the ith energy storage device, and K_{u_i_j}=(P_{m_i_j}−P_{m_k0_i_j})/P_{mMean_i_j}, wherein P_{m_i_j} is the AC side output power at the jth voltage adjustment performed on the ith energy storage device, P_{mMean_i_j} is a periodic average of the AC side output power at the jth voltage adjustment performed on the ith energy storage device that is calculated by using sliding window filtering, and P_{m_k0_i_j} is the power value excluded from the sliding window filter at the jth voltage adjustment performed on the ith energy storage device.

The embodiment 2 of the present invention further discloses an energy storage device alternating current multi-phase system, which includes a plurality of energy storage devices, a system load and at least one stand-alone load, wherein the plurality of energy storage devices are in communication with each other, the AC output side live wires of the plurality of energy storage devices are respectively connected to the system load, and the neutral wires of the plurality of energy storage devices are connected to the neutral wire common point of the system load; the AC output side of at least one energy storage device in the plurality of energy storage devices is separately connected with a stand-alone load; and the energy storage device alternating current multi-phase system adopts the electric quantity balance control method as described in the above embodiment 2 to perform electric quantity balance control on the plurality of energy storage devices. The stand-alone load is a single-phase load connected to each independent energy storage power supply, and the stand-alone load of each energy storage power supply consumes the battery power of the corresponding energy storage power supply.

It further includes the following steps before the step S1: enabling the plurality of energy storage devices to communicate with each other for allocation of master and slave devices, and determining one of the plurality of energy storage devices as the master device and the other energy storage devices as the slave devices. In some embodiments, the master device is configured to: send a power frequency phase signal to the slave device when the power frequency cycle of the master device crosses zero; obtain the remaining electric quantities of the master device and each slave device; obtain the target voltage values of the master device and each slave device according to the electric quantity balance control method of the above embodiment 2 and send the target voltage value to the corresponding slave device. The slave device is configured to: obtain and track the power frequency phase signal sent by the master device, and control the power frequency phase of the slave device to lag behind the power frequency phase of the master device.

In some embodiments, the number of the energy storage devices is two, the energy storage device alternating current multi-phase system is a split-phase dual live-wire system, and the power frequency phase difference between the two energy storage devices is 180°. In some other embodiments, the number of the energy storage devices is three, the energy storage device alternating current multi-phase system is a three-phase four-wire system, and the power frequency phase difference between the three energy storage devices is 120°.

The embodiment 2 of the present invention further discloses a storage medium storing a computer program, wherein the computer program is set to be executable by a processor to execute the steps of the electric quantity balance control method described in the above embodiment 2.

Optionally, the above storage medium may include, but is not limited to, various media that can store computer programs, such as a USB flash disk, a Read-Only Memory (ROM), a Random Access Memory (RAM), a mobile hard disk, a magnetic disk or an optical disk.

The energy storage device alternating current multi-phase system and the electric quantity balance control method therefor provided in the above embodiment 2 of the present invention will be further described hereinafter with reference to specific preferred embodiments.

The embodiment 2 of the present invention preferably provides a split-phase dual-live wire system, which is composed of two independent energy storage power supplies with AC output sides connected in series with an AC output phase difference of 180°, and neutral wires connected together to form a split-phase LI-N-L2 AC power supply system. Through the split-phase double-live wire system, the output AC voltage can be multiplied.

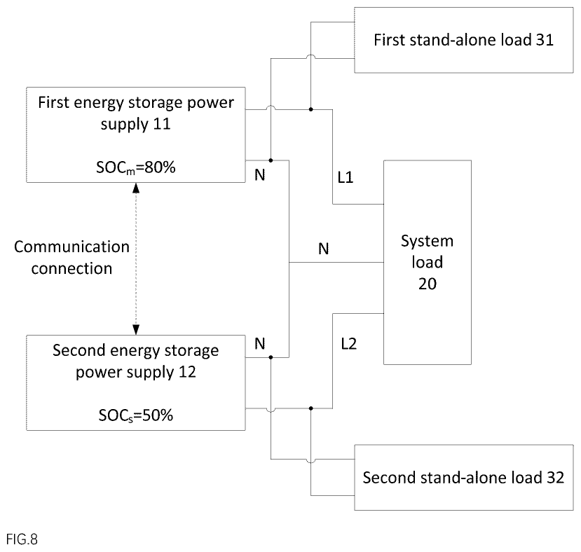

Specifically, as shown in FIG. 8, the split-phase dual-live wire system includes a first energy storage power supply 11 and a second energy storage power supply 12 that can output alternating current off grid, a system load 20 (in this embodiment, the system load is a line-to-line load), a first stand-alone load 31 and a second stand-alone load 32. The first energy storage power supply 11 and the second energy storage power supply 12 are in communication with each other, the AC output side neutral wires (N) of the first energy storage power supply 11 and the second energy storage power supply 12 are connected to the neutral wire common point of the system load 20, the live wire (L1) of the first energy storage power supply 11 and the live wire (L2) of the second energy storage power supply 12 are respectively connected to the system load 20, the AC output side of the first energy storage power supply 11 is connected to the first stand-alone load 31, and the AC output side of the second energy storage power supply 12 is connected to the second stand-alone load 32.

The output voltage U₁ of the first energy storage power supply 11 and the output voltage U₂ of the second energy storage power supply 12 in the split-phase dual-live wire system at the initial moment are both rated AC output voltage value U_{rated} (100 Vac or 120 Vac).

In some embodiments, the electric quantity balance control method of the split-phase dual-live wire system includes the following steps:
C1: allocating master and slave devices;

The specific steps of allocating master and slave devices in this embodiment are the same as the specific steps of allocating master and slave devices in the embodiment 1. As shown in FIG. 3, the specific steps include: enabling two independent energy storage power supplies to communicate with each other, and then allocating the master and slave devices in a competitive manner to confirm whether the power supply is the master device; if the power supply is the master device, then obtaining its current remaining electric quantity SOCₘ, and the current remaining electric quantity SOCₛ of the slave device, and calculating the target voltage value U_{mRef} of the master device and the target voltage value U_{sRef} of the slave device, and then sending the corresponding target voltage value U_{sRef} to the slave device, and further sending a phase synchronization signal to the slave device when the master device crosses zero; if the power supply is not the master device, then obtaining the power frequency phase Thetam currently output by the master device, tracking the master device phase, controlling the slave device phase to lag behind the master device by 180 degrees, and obtaining its target voltage value U_{sRef} sent by the master device.

In this specific embodiment, the first energy storage power supply 11 and the second energy storage power supply 12, which are independent of each other, communicate with each other to compete for the master device so that one is automatically allocated to be the master device and the other is allocated to be the slave device. In this embodiment, taking the case where the first energy storage power supply 11 is allocated to be the master device and the second energy storage power supply 12 is allocated to be the slave device as an example, then Uₘ=U₁=U_{rated}, Uₛ=U₂=U_{rated}, wherein U₁ represents the output voltage of the first energy storage power supply 11, U₂ represents the output voltage of the second energy storage power supply 12, Uₘ represents the output voltage of the master device, and Uₛ represents the output voltage of the slave device. The output voltages of the master device and the slave device are all equal to the rated AC output voltage value U_{rated} at the initial moment. The master device is configured to obtain its remaining electric quantity SOCₘ and the current remaining electric quantity SOCₛ of the slave device, calculate the target voltage value U_{mRef} of the master device and the target voltage value U_{sRef} of the slave device, and then send the corresponding target voltage value U_{sRef} to the slave device. The master device is further configured to send a power frequency phase signal to the slave device when the power frequency cycle of the master device crosses zero. The slave device is configured to obtain and track the power frequency phase signal sent by the master device, and at the same time, control the output phase of the slave device to differ from that of the master device by 180° and obtain its target voltage value U_{sRef} sent by the master device.

In addition, it should be noted that in some embodiments, the master and slave devices may also be allocated in other ways for the energy storage power supplies. For example, one of the energy storage devices is taken as the master device by separately providing a control unit in the energy storage device, and other energy storage devices are taken as the slave devices. In the above embodiment, only one slave device is involved, and in the case involving multiple slave devices, the address allocation of slave devices can be done by any existing slave device address allocation method. For example, 1) address allocation is completed by free competition; 2) the address is set for each slave device by setting the dip switch; 3) the address of each slave device is set through the keyboard or human-machine interface; 4) the address of the slave devices is set one by one through the computer serial port software; 5) the slave device inquires the status of the bus to constantly wait for the idle state to communicate with the master device, and the address is reassigned if there is a station address conflict.

C2: obtaining remaining electric quantities of a plurality of energy storage power supplies, and calculating an average value of the remaining electric quantities of the plurality of energy storage power supplies; and then subtracting the average value from the remaining electric quantity of each energy storage power supply to obtain a corresponding difference, and for each energy storage power supply, if the corresponding difference is greater than 0, increasing an output voltage of the energy storage power supply so as to increase output power of the energy storage power supply, otherwise, if the corresponding difference is less than 0, reducing the output voltage of the energy storage power supply so as to decrease the output power of the energy storage power supply; and iteratively executing the aforesaid steps until the remaining electric quantities of all the energy storage power supplies become equal.

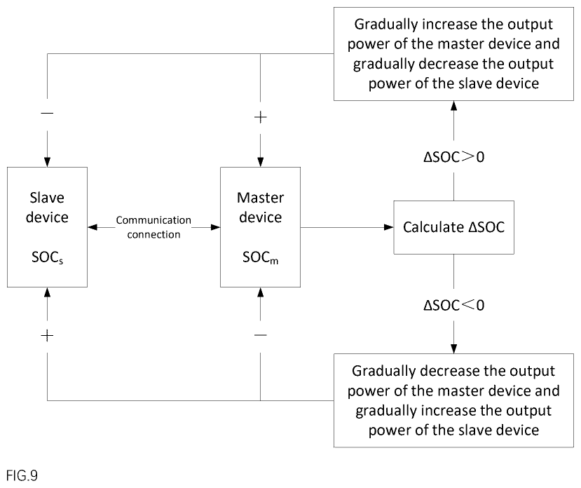

In this embodiment, the difference between the remaining electric quantities of the two energy storage power supplies is directly obtained, and electric quantity balance and output voltage control are carried out according to the difference being greater than 0 or less than 0. Specifically, as shown in FIG. 9, the master device calculates the current SOC difference between the master device and the slave device, denoted as: ΔSOC=SOCₘ−SOCₛ, and the master device enters the electric quantity balance-output voltage control mode based on the current SOC difference ΔSOC.

(1) If the master device determines that the current ΔSOC>0, then the current electric quantity of the master device is higher than that of the slave device; the master device increases the output power and the slave device decreases the output power, thus realizing SOC equalization;

(2) if the master device determines that the current ΔSOC<0, then the current electric quantity of the master device is lower than that of the slave device; the master device decreases the output power and the slave device increases the output power, thus realizing SOC equalization.

The output port wire voltage U_{LL} (i.e., the line voltage between L1 and L2) of the system load 20 is equal to the sum of the master device output voltage Uₘ, and the slave device output voltage Uₛ: U_{LL}=Uₘ+Uₛ. In order to ensure the stability of on-load output, the split-phase dual-live wire system controls the output port wire voltage U_{LL} to remain constant, i.e., 2 times of the rated voltage U_{rated}, such that U_{LL}=U_{rated}*2. Therefore, the total output voltage of the split-phase dual-live wire system composed of two independent energy storage power supplies remains constant, i.e., Uₘ+Uₛ=U_{rated}*2. Moreover, the AC output sides of the two energy storage power supplies in the split-phase dual-live wire system are connected in series, so the AC side currents of the two energy storage power supplies are equal, i.e., Iₘ=Iₛ, wherein Iₘ is the current of the master device (i.e., the first energy storage power supply 11) and Iₛ is the current of the slave device (i.e., the second energy storage power supply 12).

The output currents of the two energy storage power supplies in the split-phase double-live wire system are equal, so the adjustment of the output power of the energy storage power supply is realized by adjusting the AC output voltage. For example, if it is needed to increase the output power Pₘ, of the master device, then it is necessary to increase the current output voltage Uₘ, of the energy storage power supply to its corresponding target voltage value U_{mRef}, where U_{mRef}=U_{rated}+ΔUₜₒₜₐₗ and Pₛ=Uₘ*Iₘ. Moreover, the output wire voltage of the split-phase dual-live wire system is defined by U_{LL}=U_{rated}*2=Uₘ+Uₛ. Since the output wire voltage of the system load 20 remains constant, when the output voltage of the master device increases, the slave device should correspondingly reduce its output voltage (reducing the current output voltage Uₛ of the energy storage power supply to its corresponding target voltage value U_{sRef}), to decrease the output power thereof, i.e., U_{sRef}=U_{rated}−ΔUₜₒₜₐₗ, Pₛ=Uₛ*Iₛ.

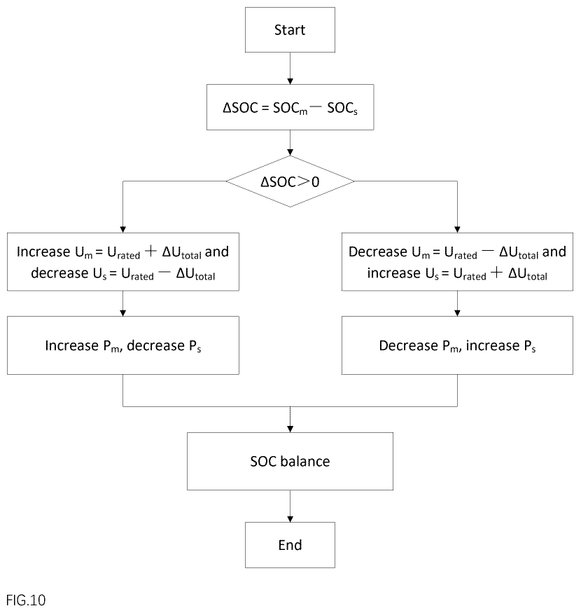

As shown in FIG. 10, when ΔSOC>0, the output voltage Uₘ, of the master device is increased, i.e., Uₘ=U_{mRef}=U_{rated}+ΔUₜₒₜₐₗ, and the output voltage Uₛ of the slave device is decreased, i.e., Uₛ=U_{sRef}−U_{rated}−ΔUₜₒₜₐₗ, so as to further increase the output power Pₘ, of the master device and decrease the output power Pₛ of the slave device, thus realizing SOC equalization. When ΔSOC<0, the output voltage Urn of the master device is decreased, i.e., Uₘ=U_{mRef}=U_{rated}−ΔUₜₒₜₐₗ, and the output voltage Uₛ of the slave device is increased, i.e., Uₛ=U_{sRef}−U_{rated}+ΔUₜₒₜₐₗ, so as to further decrease the output power Pₘ, of the master device and increase the output power Pₛ of the slave device, thus realizing SOC equalization.

The total target voltage adjustment value ΔUₜₒₜₐₗ=(ΔSOC/2)*U_{rated}, wherein SOCₘ, SOCₛ and ΔSOC are all numbers from 0 to 1, which are expressed in percentage form. For example, the SOCₘ of the master device is 80%, the SOCₛ of the slave device is 50% and ΔSOC is 30%.

In the present invention, it is considered that if the adjustment range of ΔUₜₒₜₐₗ is too large, then the SOC balance processing rate of the two energy storage power supplies will be large, which may affect the stability of the stand-alone load. In order to improve the stability of the stand-alone load, the preferred embodiment of the present invention realizes the adjustment of ΔUₜₒₜₐₗ through two-stage judgment and calculation processing of ΔSOC and stand-alone output load power, and at the same time adopting the output voltage variable step control method. The specific implementation method is as follows:

(1) The master device calculates the first target voltage adjustment value ΔU_{SOC_j} at the jth voltage adjustment according to the current SOC difference ΔSOC_ⱼ between the master device and the slave device:

$$Δ {U}_{SOC \_ j} = ( Δ {SOC}_{\_ j} / 2 ) \times {U}_{rated} \times r 1 ,$$

wherein r1 is a proportional coefficient, which is usually related to the stand-alone AC output voltage and meets the utilization voltage range of conventional appliances; for example, the stand-alone AC output is 110V, and the value of r1 is (10%, 20%).

(2) Because the output voltage of each energy storage power supply is dynamically adjusted, in order to prevent the power fluctuation of the stand-alone load caused by the output voltage adjustment, output voltage smoothing processing at output power adjustment is additionally performed.

Each energy storage power supply calculates the second target voltage adjustment value ΔU_{p_j} at the jth voltage adjustment according to the change of the respective AC side output power P_{m_j} by the following steps:
a. calculating the periodic average P_{mMean_j} of the AC output power at the jth voltage adjustment performed on the master device or the slave device by using sliding window filtering;
b. recording the power value P_{m_k0_j} that is excluded from the sliding window filter at the jth voltage adjustment (the value at the beginning of the sliding window);
c. calculating the power change ratio K_{u_j} at the jth voltage adjustment:

$${K}_{u \_ j} = ( {P}_{m \_ j} - {P}_{m \_ k 0 \_ j} ) / {P}_{mMean \_ j} ;$$

d. calculating the second target voltage adjustment value ΔU_{p_j} at the jth voltage adjustment according to the output power fluctuation (the power change ratio K_{u_j}):

$$Δ {U}_{p \_ j} = {K}_{u \_ j} * Δ {U}_{SOC \_ j} .$$

(3) In order to satisfy the SOC dynamic adjustment rate and the stability of the system during voltage adjustment, the following equation may be adopted to calculate the target voltage adjustment value at the jth voltage adjustment:

$$Δ {U}_{\_ j} = Δ {U}_{SOC \_ j} * r 2 + Δ {U}_{p \_ j} * r 3 ;$$

wherein r2 and r3 are weights, and r2+r3=1; if the weight of r3 is greater (r3>r2), then the stand-alone power is more stable; and if the weight of r2 is greater (r2>r3), then the system adjustment rate will be faster.

In a specific embodiment, the voltage adjustment step size may be selected to be obtained by averaging:

$$Δ {U}_{\_ j} = Δ {U}_{SOC \_ j} * 0.5 + Δ {U}_{{p}_{j}} * 0.5 .$$

By obtaining the target voltage adjustment value at the jth voltage adjustment, the stepping target voltage value corresponding to each voltage adjustment of the master device or the slave device can be calculated. When ΔSOC>0, the stepping target voltage value at the jth voltage adjustment performed on the master device is defined by U_{mRef_j}=U_{rated}+ΔU_ⱼ, and the stepping target voltage value at the jth voltage adjustment performed on the slave device is defined by U_{sRef}=U_{rated}−ΔU_ⱼ. When ΔSOC<0, the stepping target voltage value at the jth voltage adjustment performed on the master device is defined by U_{mRef_j}=U_{rated}−ΔU_ⱼ, and the stepping target voltage value at the jth voltage adjustment performed on the slave device is defined by U_{sRef}=U_{rated}+ΔU_ⱼ.

In this embodiment, two factors are taken into consideration for the target voltage adjustment value ΔU_ⱼ at the jth voltage adjustment: one factor is ΔU_{SOC_j}, which is used for the balance of electric quantities of the energy storage power supplies, the value of which is 10% to 20% of the total target voltage adjustment value ΔUₜₒₜₐₗ, and which reflects the rapid electric quantity balance of the system; the other factor is ΔU_{p_j}, which is used for making the power of each separate energy storage power supply more stable, and which reflects the stability of each energy storage power supply.

In order to make the split-phase dual-live wire system achieve the total electric quantity balance, the sum of voltages that need to be adjusted for the respective energy storage power supplies is the total target voltage adjustment value ΔUₜₒₜₐₗ (if ΔSOC>0, the voltage of the master device is increased by ΔUₜₒₜₐₗ, and the voltage of the slave device is decreased by ΔUₜₒₜₐₗ; if ΔSOC<0, the voltage of the master device is decreased by ΔUₜₒₜₐₗ and the voltage of the slave device is increased by ΔUₜₒₜₐₗ). However, in the present invention, the adjustment is not completed in one step, and instead, both ΔU_{SOC_j} and ΔU_{p_j} are taken into consideration, and the target voltage adjustment value for each time is ΔU_ⱼ=ΔU_{SOC_j}*r2+ΔU_{p_j}*r3; the output voltages of the master device and the slave device are adjusted stepwise/gradually, with ΔUₜₒₜₐₗ=ΔU_₁+ΔU_₂+ΔU_₃+ . . . +ΔU__{M,j}=1,2,3, . . . , M. It means that it takes M adjustments to finally reach the total electric quantity balance.

Through the stepwise and gradual adjustment, the master device reaches the target voltage value U_{mRef} and the slave device reaches the target voltage value U_{sRef}, so as to realize the stepwise and gradual adjustment of the output power Pₘ of the master device and the output power Pₛ of the slave device, thereby further realizing the adjustment of the battery discharge rate of the energy storage power supply so that the SOC of the two energy storage power supplies are actively balanced, and at the same time the whole system is more stable.

The embodiment 2 of the present invention further preferably provides a three-phase four-wire system, which is composed of three independent energy storage power supplies with AC output sides connected in star configuration with respective AC output phase difference of 120°, and neutral wires connected together to form a three-phase AC power supply system.

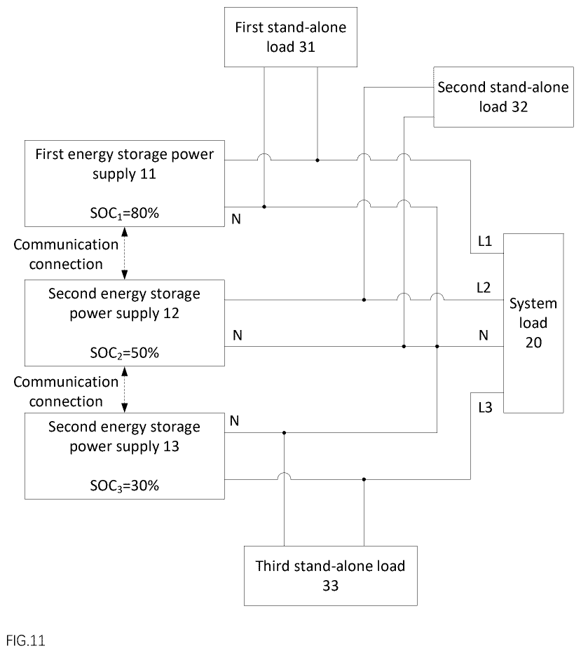

Specifically, as shown in FIG. 11, the three-phase four-wire system includes a first energy storage power supply 11, a second energy storage power supply 12 and a third energy storage power supply 13 that can output alternating current off grid, a system load 20 (in this embodiment, the system load is a three-phase load), a first stand-alone load 31, a second stand-alone load 32 and a third stand-alone load 33. The first energy storage power supply 11, the second energy storage power supply 12 and the third energy storage power supply 13 are in communication with each other, the AC output side neutral wires (N) of the first energy storage power supply 11, the second energy storage power supply 12 and the third energy storage power supply 13 are connected to the neutral wire common point of the system load 20, the live wire (L1) of the first energy storage power supply 11, the live wire (L2) of the second energy storage power supply 12 and the live wire (L3) of the third energy storage power supply 13 are respectively connected to the system load 20, the AC output side of the first energy storage power supply 11 is connected to the stand-alone load 31, the AC output side of the second energy storage power supply 12 is connected to the stand-alone load 32, and the AC output side of the third energy storage power supply 13 is connected to the stand-alone load 33.

The output voltage U₁ of the first energy storage power supply 11, the output voltage U₂ of the second energy storage power supply 12 and the output voltage U₃ of the third energy storage power supply 13 in the three-phase four-wire system at the initial moment are all rated AC output voltage value U_{rated} (100 Vac or 120 Vac).

In some embodiments, the electric quantity balance control method of the three-phase four-wire system includes the following steps:
D1: allocating master and slave devices;

The specific steps of allocating the master and slave devices include: enabling three independent energy storage power supplies to communicate with each other, and automatically allocating the master and slave devices in a competitive manner so that one of the energy storage power supplies is determined as the master device while the other two energy storage power supplies are determined as the slave devices. The specific steps in the master and slave device allocation in this three-phase four-wire system differ from those in the split-phase dual-live wire system only in that the phase difference between the master device and the respective slave devices is 120°, while other specific process steps are the same, and this will not be further described herein.

D2: obtaining remaining electric quantities of a plurality of energy storage power supplies, and calculating an average value of the remaining electric quantities of the plurality of energy storage power supplies; and then subtracting the average value from the remaining electric quantity of each energy storage power supply to obtain a corresponding difference, and for each energy storage power supply, if the corresponding difference is greater than 0, increasing an output voltage of the corresponding energy storage power supply so as to increase output power of the energy storage power supply, otherwise, if the corresponding difference is less than 0, reducing the output voltage of the corresponding energy storage power supply so as to decrease the output power of the energy storage power supply; and iteratively executing the aforesaid steps until the remaining electric quantities of all the energy storage power supplies become equal.

In the three-phase four-wire system, the master device obtains the remaining electric quantities SOC₁, SOC₂, SOC₃ of the energy storage power supplies; the phase difference between the master device and the respective slave devices is 120°, and the total output voltage of the three-phase four-wire system composed of the three independent energy storage power supplies remains constant.

The average value SOC of the three energy storage power supplies is calculated: SOCₐᵥₑ=(SOC₁+SOC₂+SOC₃)/3, and then the current SOCᵢ(i=1, 2, 3) of the energy storage power supplies is compared with SOCₐᵥₑ. If SOCᵢ is equal to SOCₐve, then there is no need to increase or decrease the output power; if SOCᵢ<SOCₐᵥₑ, then the output power is decreased; and if SOCᵢ>SOCₐᵥₑ, then the output power is increased.

Because the total output voltage remains constant and the three-phase load remains unchanged, the total current I is unchanged, and thus the output power of each energy storage power supply is further increased or decreased by adjusting the output voltage of each energy storage power supply in the present invention. The output voltage U₁ of the first energy storage power supply 11 is adjusted to its corresponding target voltage value U_{1Ref}=U_{rated}+ΔU₁ₜₒₜₐₗ, the output voltage U₂ of the second energy storage power supply 12 is adjusted to its corresponding target voltage value U_{2Ref}=U_{rated}+ΔU₂ₜₒₜₐₗ; the output voltage U₃ of the third energy storage power supply 13 is adjusted to its corresponding target voltage value U_{3Ref}=U_{rated}+ΔU₃ₜₒₜₐₗ; wherein ΔU₁ₜₒₜₐₗ+ΔU₂ₜₒₜₐₗ+ΔU₃ₜₒₜₐₗ=0. If the total target voltage adjustment valueΔU₁ₜₒₜₐₗ(i=1,2,3) is zero, then it means that the remaining electric quantity of the corresponding energy storage power supply SOCᵢ=SOCₐᵥₑ, and there is no need to increase or decrease the output power; if ΔUᵢₜₒₜₐₗ is negative, then it means that for the corresponding energy storage power supply, SOCᵢ<SOCₐᵥₑ, and the output power needs to be decreased; and if ΔUᵢₜₒₜₐₗ is positive, then it means that for the corresponding energy storage power supply, SOCᵢ>SOCₐᵥₑ, and the output power needs to be increased.

The equation for calculation of the total target voltage adjustment value is: ΔUᵢₜₒₜₐₗ=(SOCᵢ−SOCₐᵥₑ)×U_{rated}, i=1,2,3, and U_{rated} is the rated voltage of the energy storage power supply. Both SOCᵢ and SOCₐᵥₑ are numbers from 0 to 1, which are expressed in percentage form. For example, the remaining electric quantity SOC₁ of the first energy storage power supply 11 is 80%, the remaining electric quantity SOC₂ of the second energy storage power supply 12 is 50%, the remaining electric quantity SOC₃ of the third energy storage power supply 13 is 30%, and SOCₐᵥₑ is 53.3%.

In the present invention, it is considered that if the adjustment range of ΔUᵢₜₒₜₐₗ is too large, then the SOC balance processing rate of the energy storage power supplies will be large, which may affect the stability of the stand-alone load. In order to improve the stability of the stand-alone load, the embodiment 2 of the present invention realizes the adjustment of ΔUᵢₜₒₜₐₗ through two-stage judgment and calculation processing of SOC difference and stand-alone output load power, and at the same time adopting the output voltage variable step control method. The specific implementation method is as follows:

(1) Each of the energy storage power supplies calculates its first target voltage adjustment value ΔU_{sOC_i_j} at the jth voltage adjustment respectively:

$$Δ {U}_{SOC \_ i \_ j} = ( {SOC}_{i \_ j} - {SOC}_{ave} ) \times {U}_{rated} \times r {1}_{i} ,$$

wherein r1ᵢ is a proportional coefficient, which is usually related to the stand-alone AC output voltage and meets the utilization voltage range of conventional appliances; for example, the stand-alone AC output is 110V, and the value of r1ᵢ is (10%, 20%).

(2) Because the output voltage of each energy storage power supply is dynamically adjusted, in order to prevent the power fluctuation of the stand-alone load caused by the output voltage adjustment, output voltage smoothing processing at output power adjustment is additionally performed.

Each energy storage power supply calculates its second target voltage adjustment value ΔU_{p_i_j} at the jth voltage adjustment according to the change of the respective AC side output power P_{m_i_j} by the following steps:
a. calculating the periodic average P_{mMean_i_j} of the AC output power at the jth voltage adjustment of each energy storage power supply by using sliding window filtering;
b. recording the power value P_{m_k0_i_j} that is excluded from the sliding window filter at the jth voltage adjustment (the value at the beginning of the sliding window);
c. calculating the power change ratio K_{u_i_j} at the jth voltage adjustment:

$${K}_{u \_ i \_ j} = ( {P}_{m \_ i \_ j} - {P}_{m \_ k 0 \_ i \_ j} ) / {P}_{mMean \_ i \_ j} ;$$

d. calculating the second target voltage adjustment value ΔU_{p_i_j} at the jth voltage adjustment of each energy storage power supply according to the output power fluctuation (the power change ratio K_{u_i_j}):

$$Δ {U}_{p \_ i \_ j} = {K}_{u \_ i \_ j} * Δ {U}_{SOC \_ i \_ j} .$$

(3) In order to satisfy the SOC dynamic adjustment rate and the stability of the system during voltage adjustment, the following equation may be adopted to calculate the target voltage adjustment value at the jth voltage adjustment performed on the ith energy storage device:

$$Δ {U}_{i \_ j} = Δ {U}_{SOC \_ i \_ j} * r {2}_{i} + Δ {U}_{p \_ i \_ j} * r {3}_{i} ;$$

wherein r2ᵢ and r3ᵢ are weights, and r2ᵢ+r3ᵢ=1; if the weight of r3ᵢ is greater (r3ᵢ>r2ᵢ), then the stand-alone power is more stable; and if the weight of r2ᵢ is greater (r2ᵢ>r3ᵢ), then the system adjustment rate will be faster.

By obtaining the target voltage adjustment value at the jth voltage adjustment performed on the ith energy storage device, the stepping target voltage value corresponding to each voltage adjustment of the energy storage power supply can be calculated. When SOC_{i_j}>SOCₐᵥₑ (SOC_{i_j} is the remaining electric quantity of the ith energy storage device at the jth voltage adjustment), the stepping target voltage value at the jth voltage adjustment performed on the ith energy storage device is U_{iRef}=U_{rated}+ΔU_{i_j}. When SOC_{i_j}<SOCₐᵥₑ (SOC_{i_j} is the remaining electric quantity of the ith energy storage device at the jth voltage adjustment), the stepping target voltage value at the jth voltage adjustment performed on the ith energy storage device is U_{iRef}=U_{rated}−ΔU_{i_j}.

In this embodiment, two factors are taken into consideration for the target voltage adjustment value ΔU_{i_j} at the jth voltage adjustment performed on the ith energy storage device: one factor is ΔU_{SOC_i_j}, which is used for the balance of electric quantities of the energy storage power supplies, the value of which is 10% to 20% of the total target voltage adjustment value ΔUᵢₜₒₜₐₗ, and which reflects the rapid electric quantity balance of the system; the other factor is ΔU_{p_i_j}, which is used for making the power of each separate energy storage power supply more stable, and which reflects the stability of each energy storage power supply.

In order to make the three-phase four-wire system achieve the total electric quantity balance, the sum of voltages that need to be adjusted for the respective energy storage power supplies is the total target voltage adjustment value ΔUᵢₜₒₜₐₗ (i=1, 2, 3, and represents the ith energy storage power supply in the system). However, in the present invention, the adjustment is not completed in one step, and instead, both ΔU_{SOC_i_j} and ΔU_{p_i_j} are taken into consideration, and the target voltage adjustment value for each time is ΔU_{i_j}=ΔU_{SOC_i_j}*r2+ΔU_{p_i_j}*r3; the output voltages of the master device and the slave device are adjusted stepwise/gradually, with ΔUᵢₜₒₜₐₗ=ΔU__{i_1}+ΔU__{i_2}+ΔU__{i_3}+ . . . +ΔU__{i_M},j=1,2,3, . . . , M. It means that it takes M adjustments to finally reach the total electric quantity balance.

Through the stepwise and gradual adjustment, the energy storage power supply reaches the target voltage value U_{iRef}, so as to realize the stepwise and gradual adjustment of the output power P_{m_i} of the energy storage power supply, thereby further realizing the adjustment of the battery discharge rate of the energy storage power supply so that the SOC of the energy storage power supplies are actively balanced, and at the same time the whole system is more stable.

By adopting the electric quantity balance control method provided in the embodiment 2 of the present invention, the split-phase dual-live wire system and the three-phase four-wire system described above control the output wire voltage to be constant, thereby providing stable power support for the load. Meanwhile, the output voltage of each single energy storage power supply can be adjusted in real time according to the remaining electric quantity SOC of each energy storage power supply and the power of the load so as to: increase the output on-load power of the energy storage power supply with high electric quantity, and decrease the output on-load power of the energy storage power supply with low electric quantity. Thus, the active electric quantity balance control of the split-phase double-live wire system and the three-phase four-wire system is realized, and the problem that the on-load endurance of the system is shortened due to inconsistency of the remaining electric quantities SOC is effectively solved. Meanwhile, the stability of the respective stand-alone load is taken into consideration at each adjustment of the output voltage, and by gradually adjusting the output voltage of each energy storage power supply stepwise in a cyclic manner, the power fluctuation of the stand-alone load is prevented so that the stand-alone load can work and be used normally under the rated voltage and within a certain voltage variation range, thereby making the system more stable. On the one hand, it avoids the inconsistency of power consumption of the energy storage power supplies included in the system, so that the battery duration of the energy storage power supplies is consistent. On the other hand, it ensures that all kinds of electrical devices can work and be used normally under the rated voltage and within a certain voltage variation range, and at the same time, it also avoids the operation of stand-alone loads under the condition of high or low voltages, thereby greatly prolonging the service life of the electrical devices, reducing energy consumption, reducing the possibility of electrical device damage to the greatest extent, and ensuring electrical safety.

The background of the present invention may contain background information about the problem or context of the present invention, rather than describing the prior art by others. Therefore, what is contained in the background section is not an admission of the applicant to the prior art.

What described above is a further detailed description of the present invention in combination with specific/preferred embodiments, and it should not be considered that the specific implementation of the present invention is limited to these descriptions. For those of ordinary skill in the art, several substitutions or modifications to these described embodiments can be made without departing from the concept of the present invention, and these substitutions or modifications should all be regarded as belonging to the scope claimed in the present invention. In the description of this specification, descriptions referring to the terms “one embodiment”, “some embodiments”, “preferred embodiments”, “examples”, “specific examples” or “some examples” mean that specific features, structures, materials or characteristics described in connection with this embodiment or example are included in at least one embodiment or example of the present invention. In this specification, the schematic expressions of the above terms are not necessarily aimed at the same embodiment or example. Moreover, the specific features, structures, materials or characteristics described may be combined in any one or more embodiments or examples in a suitable manner. In addition, those skilled in the art can integrate and combine different embodiments or examples and features of different embodiments or examples described in this specification without contradiction therebetween. Although the embodiments of the present invention and advantages thereof have been described in detail, it should be understood that various changes, substitutions and alterations can be made herein without departing from the scope defined by the appended claims.

1. An electric quantity balance control method for an energy storage device alternating current multi-phase system, comprising the following steps:
S1: obtaining remaining electric quantities of a plurality of energy storage devices;
S2: calculating an average value of the remaining electric quantities of the plurality of energy storage devices; and
S3: subtracting the average value calculated in step S2 from the remaining electric quantity of each energy storage device to obtain a corresponding difference, and
for each energy storage device, if the corresponding difference is greater than 0, increasing an output voltage of the energy storage device to increase its output power;
otherwise, if the corresponding difference is less than 0, reducing the output voltage of the energy storage device to decrease its output power.

2. The electric quantity balance control method according to claim 1, wherein the step S3 specifically comprises:
subtracting the average value calculated in step S2 from the remaining electric quantity of the ith energy storage device to obtain the difference, and adjusting the output voltage of the corresponding energy storage device to a target voltage value to adjust the output power of the energy storage device, wherein the target voltage value is defined by U_{iRef}=U_{rated}+ΔUᵢ, U_{rated} is the rated voltage of the energy storage device, ΔUᵢ is a target voltage adjustment value calculated according to the difference, i=1 to n, and n is the number of the energy storage devices.

3. The electric quantity balance control method according to claim 2, wherein the target voltage adjustment value is defined by ΔUᵢ=(SOCᵢ−SOCₐᵥₑ)×U_{rated}, SOCₐᵥₑ is the average value calculated in step S2, SOCᵢ is the remaining electric quantity of the ith energy storage device.

4. The electric quantity balance control method according to claim 1, wherein, after step S3, the method further comprises:
iteratively executing steps S1 to S3 until the remaining electric quantities of all the energy storage devices become equal.

5. The electric quantity balance control method according to claim 4, wherein the step S3 specifically comprises:
subtracting the average value calculated in step S2 from the remaining electric quantity of the ith energy storage device to obtain the difference, and adjusting the output voltage of the corresponding energy storage device to a stepping target voltage value to adjust the output power of the energy storage device, wherein the stepping target voltage value is defined by U_{iRef_j}=U_{rated}+ΔU_{i_j}, U_{rated} is the rated voltage of the energy storage device, ΔU_{i_j} is a target voltage adjustment value at the jth voltage adjustment performed on the ith energy storage device that is calculated according to the difference, i=1 to n, n is the number of the energy storage devices, and j is the current number of times for voltage adjustment.

6. The electric quantity balance control method according to claim 5, wherein the target voltage adjustment value at the jth voltage adjustment performed on the ith energy storage device is defined by ΔU_{i_j}=ΔU_{sOC_i_j}*r2ᵢ+ΔU_{p_i_j}*r3ᵢ, ΔU_{sOC_i_j} is a first target voltage adjustment value at the jth voltage adjustment performed on the ith energy storage device that is calculated according to the difference, ΔU_{p_i_j} is a second target voltage adjustment value at the jth voltage adjustment performed on the ith energy storage device that is calculated according to the change of the AC side output power of the ith energy storage device, r2ᵢ and r3ᵢ are weights, and r2ᵢ+r3ᵢ=1.

7. The electric quantity balance control method according to claim 6, wherein the first target voltage adjustment value at the jth voltage adjustment performed on the ith energy storage device is defined by:
ΔU_{sOC_i_j}=(SOC_{i_j}−SOCₐᵥₑ)×U_{rated}×r1ᵢ, r1ᵢ is a proportional coefficient, SOCₐᵥₑ is the average value calculated in step S2, SOC_{i_j} is the remaining electric quantity of the ith energy storage device.

8. The electric quantity balance control method according to claim 7, wherein the value of r1ᵢ is 10% to 20%.

9. The electric quantity balance control method according to claim 6, wherein the second target voltage adjustment value at the jth voltage adjustment performed on the ith energy storage device is defined by ΔU_{p_i_j}=K_{u_i_j}*ΔU_{sOC_i_j} wherein K_{u_i_j} is the power change ratio at the jth voltage adjustment performed on the ith energy storage device, and defined by
K_{u_i_j}=(P_{m_i_j}−P_{m_k0_i_j})/P_{mMean_i_j}, P_{m_i_j} is the AC side output power at the jth voltage adjustment performed on the ith energy storage device, P_{mMean_i_j} is a periodic average of the AC side output power at the jth voltage adjustment performed on the ith energy storage device that is calculated by using sliding window filtering, and P_{m_k0_i_j} is the power value excluded from the sliding window filter at the jth voltage adjustment performed on the ith energy storage device.

10. An energy storage device alternating current multi-phase system, comprising:
a plurality of energy storage devices and a system load, wherein the plurality of energy storage devices are in communication with each other, and the AC output side live wires of the plurality of energy storage devices are respectively connected to the system load, the neutral wires of the plurality of energy storage devices are connected to the neutral wire common point of the system load; and
the energy storage device alternating current multi-phase system is configured to perform electric quantity balance control on the plurality of energy storage devices using an electric quantity balance control method
wherein the electric quantity balance control method comprises:
S1: obtaining remaining electric quantities of a plurality of energy storage devices;
S2: calculating an average value of the remaining electric quantities of the plurality of energy storage devices; and
S3: subtracting the average value calculated in step S2 from the remaining electric quantity of each energy storage device to obtain a corresponding difference, and
for each energy storage device, if the corresponding difference is greater than 0, increasing an output voltage of the energy storage device to increasing its output power;
otherwise, if the corresponding difference is less than 0, reducing the output voltage of the energy storage device to decrease its output power.

11. The energy storage device alternating current multi-phase system according to claim 10, wherein the system further comprises at least one stand-alone load, and the AC output side of at least one of the plurality of energy storage devices is separately connected with the stand-alone load.

12. The energy storage device alternating current multi-phase system according to claim 10, wherein the energy storage device alternating current multi-phase system is further configured to perform the following steps before the step S1:
enabling the plurality of energy storage devices to communicate with each other for allocation of master and slave devices, and determining one of the plurality of energy storage devices as the master device and the other energy storage devices as the slave devices.

13. The energy storage device alternating current multi-phase system according to claim 12, wherein the master device is configured to:
send a power frequency phase signal to the slave device when the power frequency cycle of the master device crosses zero;
obtain the respective remaining electric quantities of the master device and each slave device;
send target voltage values to respective slave devices;
wherein the target voltage value is defined by U_{iRef}=U_{rated}+ΔUᵢ, U_{rated} is the rated voltage of the energy storage device, ΔUᵢ is a target voltage adjustment value calculated according to the difference, i=1 to n, and n is the number of the energy storage devices;
wherein the target voltage adjustment value is defined by
ΔUᵢ=(SOCᵢ−SOCₐᵥₑ)×U_{rated}, wherein SOCₐᵥₑ is the average value calculated in step S2, SOCᵢ is the remaining electric quantity of the ith energy storage device.

14. The energy storage device alternating current multi-phase system according to claim 12, wherein the slave device is configured to:
obtain and track the power frequency phase signal sent by the master device, and control the power frequency phase of the slave device to lag behind the power frequency phase of the master device.

15. The energy storage device alternating current multi-phase system according to claim 14, wherein the number of the energy storage devices is two, the energy storage device alternating current multi-phase system is a split-phase dual live-wire system, and the power frequency phase of the slave device lags behind the power frequency phase of the master device by 180°.

16. The energy storage device alternating current multi-phase system according to claim 14, wherein the number of the energy storage devices is three, the energy storage device alternating current multi-phase system is a three-phase four-wire system, the number of the slave devices is two, and the power frequency phase difference among the three energy storage devices is 120°.

17. The energy storage device alternating current multi-phase system according to claim 12, wherein the master device is configured to:
send a power frequency phase signal to the slave device when the power frequency cycle of the master device crosses zero;
obtain the respective remaining electric quantities of the master device and each slave device;
send stepping target voltage values to respective slave devices;
wherein the stepping target voltage value is defined by U_{iRef}=U_{rated}+ΔU_{i_j}, U_{rated} is the rated voltage of the energy storage device, ΔU_{i_j} is a target voltage adjustment value at the jth voltage adjustment performed on the ith energy storage device that is calculated according to the difference, i=1 to n, n is the number of the energy storage devices, and j is the current number of times for voltage adjustment;
wherein the target voltage adjustment value at the jth voltage adjustment performed on the ith energy storage device is defined by:
$$Δ {U}_{i \_ j} = Δ {U}_{SOC \_ i \_ j} * r {2}_{i} + Δ {U}_{p \_ i \_ j} * r {3}_{i} ;$$
wherein ΔU_{sOC_i_j} is a first target voltage adjustment value at the jth voltage adjustment performed on the ith energy storage device that is calculated according to the difference, ΔU_{p_i_j}, is a second target voltage adjustment value at the jth voltage adjustment performed on the ith energy storage device that is calculated according to the change of the AC side output power of the ith energy storage device, r2ᵢ and r3ᵢ are weights, and r2ᵢ+r3ᵢ=1.

18. The energy storage device alternating current multi-phase system according to claim 17, wherein the first target voltage adjustment value at the jth voltage adjustment performed on the ith energy storage device is defined by:
ΔU_{sOC_i_j}=(SOC_{i_j}−SOCₐᵥₑ)×U_{rated}×r1ᵢ, r1ᵢ is a proportional coefficient, SOCₐᵥₑ is the average value calculated in step S2, SOC_{i_j} the remaining electric quantity of the ith energy storage device.

19. The energy storage device alternating current multi-phase system according to claim 17, wherein the second target voltage adjustment value at the jth voltage adjustment performed on the ith energy storage device is defined by:
ΔU_{p_i_j}=K_{u_i_j}*ΔU_{sOC_i_j}, wherein K_{u_i_j} is the power change ratio at the jth voltage adjustment performed on the ith energy storage device, and defined by K_{u_i_j}=(P_{m_i_j}−P_{m_k0_i_j})/P_{mMean_i_j}, P_{m_i_j} is the AC side output power at the jth voltage adjustment performed on the ith energy storage device, P_{mMean_i_j} is a periodic average of the AC side output power at the jth voltage adjustment performed on the ith energy storage device that is calculated by using sliding window filtering, and P_{m_k0_i_j} is the power value excluded from the sliding window filter at the jth voltage adjustment performed on the ith energy storage device.

20. A non-volatile storage medium, storing a computer program, wherein the computer program is set to be executable by a processor to execute the electric quantity balance control method according to claim 1.
